(19) United States
(12) Patent Application Publication
(10) Pub. No.: US 2005/0081896 A1
(43) Pub. Date: Apr. 21, 2005

(54) Dish-washing machine with versatility of position

(76) Inventor: Gianluca Pardini, Lucca (IT)

Correspondence Address: THOMPSON HINE LLP, 2000 COURTHOUSE PLAZA N.E., 10 WEST SECOND STREET, DAYTON, OH, 45402-1758, US

(21) Appl. No.: 10/963,911

(22) Filed: Oct. 13, 2004

(30) Foreign Application Priority Data
Oct. 17, 2003 (IT) BO2003A000610

(51) Int. Cl. B08B 3/00

(52) U.S. Cl. 134/58 D

(57) ABSTRACT

Described herein is a dish-washing machine, in which there is provided: at least one supporting structure; a washing station, defined by one or more washing arms; a rinsing station, defined by one or more rinsing arms and by at least two attachment assemblies for attachment of the rinsing arms, which are positioned on opposite sides of the washing arms; and reversible movement means for displacing a dish rack from the washing station to the rinsing station.

The present invention relates to a dish-washing machine with versatility of position.

### BACKGROUND OF THE INVENTION

Normally, dish-washing machines used in establishments such as hotels and restaurants comprise at least one loading station, a washing station, a rinsing station, and an unloading station. The sequence of these stations and of their components is fixed and is established when the machine itself is made.

Such a constraint results in a limitation in the positioning the dish-washing machine. In fact, the dish-washing machines described above can be set only in certain positions, thus affecting the disposition of the premises that house them.

### SUMMARY OF THE INVENTION

The purpose of the present invention is to provide a dish-washing machine the technical characteristics of which will enable the drawbacks of the known art to be overcome in a simple and economically advantageous way.

The subject of the present invention is a dish-washing machine comprising: at least one washing station, defined by one or more washing arms; a rinsing station, defined by one or more rinsing arms; and movement means, designed to displace a dish rack at least from the washing station to the rinsing station; said dish-washing machine being characterized in that it comprises attachment means for said rinsing arms positioned on both sides of said washing station, and in that said movement means are reversible.

The dish-washing machine of the present invention affords the considerable advantage of reversing the direction in which the dish rack moves by displacing just the rinsing station with respect to the washing station, i.e., without modifying the position of the washing arms. In this way, it will be possible to set the dish-washing machine in the most convenient position for loading and unloading.

### BRIEF DESCRIPTION OF THE DRAWINGS

The example presented in what follows has a purely illustrative and non-limiting purpose, in order to enable a better understanding of the invention, with the aid of the annexed table of drawings, in which:

FIG. 1 is a perspective view of a dish-washing machine, with parts removed, according to a preferred embodiment of the present invention;

FIG. 2 is an exploded view of the portion of the dish-washing machine of FIG. 1; and

FIG. 3 is a perspective view of the dish-washing machine of FIG. 1 in a further configuration of operation thereof.

### DETAILED DESCRIPTION OF THE INVENTION

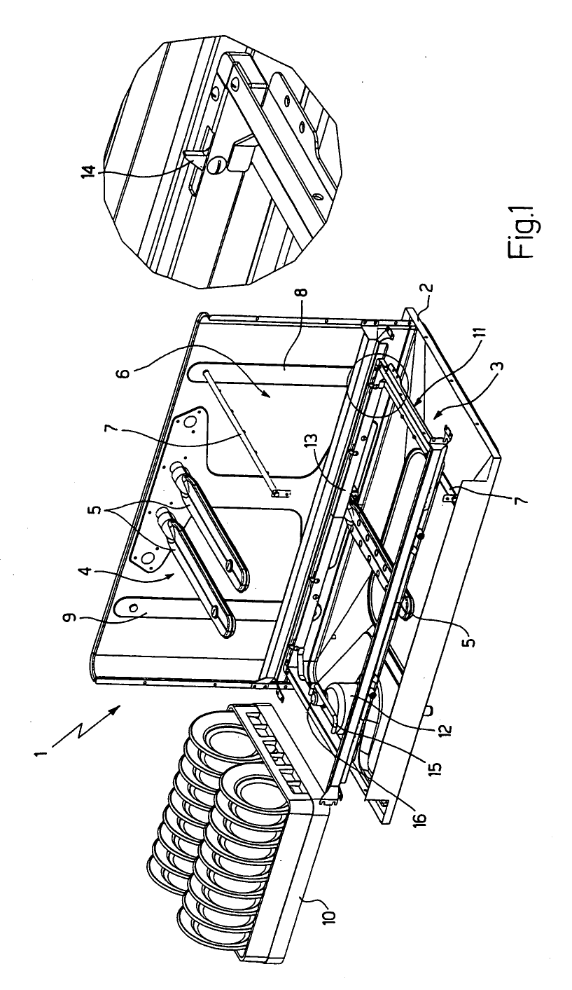

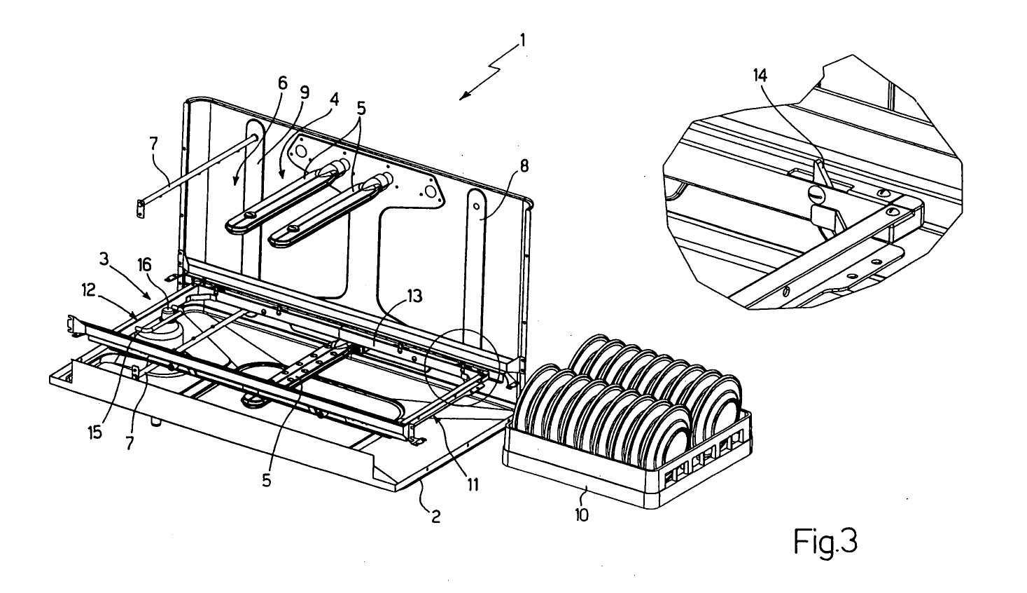

In FIGS. 1 and 3, designated as a whole by 1 is a dish-washing machine. The dish-washing machine 1 comprises: a supporting structure 2 for supporting the movement means 3; a washing station 4, defined by three washing arms 5, from which a water/detergent mixture is delivered; and a rinsing station 6, defined by two rinsing arms 7, from which the rinsing water is delivered.

The dish-washing machine 1 further comprises a first attachment assembly 8 and a second attachment assembly 9 for attachment of the rinsing arms 7. The two assemblies 8 and 9 are arranged on opposite sides with respect to the washing station 4. In this way, it is possible to fix, as desired, the position of the rinsing station 6 with respect to the washing station 4.

Since the assemblies 8 and 9 are known to a person skilled in the art, they will not be described hereinafter.

The movement means 3 have the function of displacing a dish rack 10 from the washing station 4 to the rinsing station 6, and comprise a thrust carriage 11 and an actuation assembly 12, designed to move the carriage 11 according to a reciprocating translational motion.

The thrust carriage 11 comprises a rectangular frame 13, a plurality of engagement teeth 14, hinged on two long sides 13a of the frame 13, and a handle element 15.

The actuation assembly 12 comprises a pin 16, which engages the handle element 15 and moves along a circular path and is moved by an appropriate electric motor (known and not illustrated herein). As is known, the engagement of the pin 16 with the handle element 15 enables conversion of the circular motion of the pin 16 itself into the reciprocating translational motion of the thrust carriage 11.

As is known, the engagement teeth 14 are hinged to the frame 13 in such a way that, only when the thrust carriage 11 is displaced in one direction, they remain in a vertical position so that they can exert the action of thrust on the rack 10.

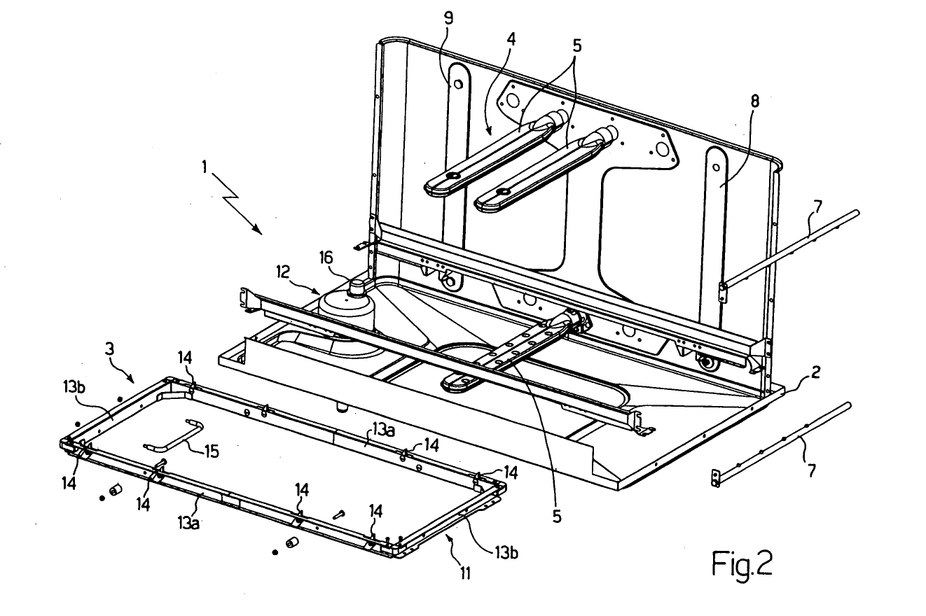

As illustrated in FIG. 2, the handle element 15 can be fixed in a removable way indifferently to one or other of the two short sides 13b of the frame 13. In this way, it will be possible to set the correct direction of advance of the rack 10 according to where the rinsing station 6 has been positioned with respect to the washing station 4.

In fact, as may be noted from the comparison of FIGS. 1 and 3, the dish-washing machine of the present invention can set the rinsing station in two different positions with respect to the washing station, which remains fixed. From a comparison of the enlarged details of FIGS. 1 and 3, it may be noted how, by replacing the short side 13b, on which the handle element 15 is fixed, and rotating the frame 13 through 180°, it is possible to set the engagement teeth 14 in the correct direction.

In use, to pass from the position of the rinsing station illustrated in FIG. 1 to the position of the rinsing station illustrated in FIG. 3, it will be necessary to dismantle the rinsing arms 7 from the attachment assembly 8 to re-install them on the assembly 9. At this point, it will be sufficient to rotate the frame 13 of the movement means 3 through 180°, having removed the handle element 15 from one of the two short sides 13b, where it was fixed, to re-install it on the opposite short side 13b.

As will emerge clearly from the foregoing description, the dish-washing machine of the present invention enables freedom of displacement of the rinsing station, and hence the loading station, according to the disposition of the premises in which the dish-washing machine itself is to be set.

1. A dish-washing machine (1) comprising: at least one supporting structure (2); a washing station (4), defined by one or more washing arms (5); a rinsing station (6), defined by one or more rinsing arms (7); and movement means (3), designed to displace a dish rack (10) at least from the washing station (4) to the rinsing station (6); said dish-washing machine being characterized in that it comprises at least two attachment assemblies (8, 9) for attachment of said rinsing arms (7) positioned on opposite sides of said washing arms (5), and in that said movement means (3) are reversible.

2. The dish-washing machine according to claim 1, characterized in that said movement means (3) comprise a thrust carriage (11) orientable according to the direction of the thrust that it is desired to exert on said dish rack (10), and an actuation assembly (12) for actuation of said thrust means (11).

3. The dish-washing machine according to claim 2, characterized in that said actuation assembly (12) is fixedly set on said supporting structure (2).

4. The dish-washing machine according to claim 3, characterized in that said thrust carriage (11) comprises a removable element (15), which is engaged by said actuation means (12) and the position of which determines the direction of the action of thrust.

5. The dish-washing machine according to claim 4, characterized in that said thrust carriage (11) comprises a frame (13), a plurality of engagement teeth (14), hinged to said frame (13), and in that said removable element is a handle element (15), designed to be fixed in a removable way alternatively on at least two opposite sides (13b) of said frame (13).

6. The dish-washing machine according to claim 5, characterized in that said engagement teeth (14) are hinged on the two long sides (13a) of said frame (13), and in that said handle element (15) can be fixed indifferently on one or other of the two short sides (13b) of said frame (13).
